(19) United States
(12) Patent Application Publication
(10) Pub. No.: US 2023/0290569 A1
(43) Pub. Date: Sep. 14, 2023

(54) WOUND CORE, METHOD OF PRODUCING WOUND CORE AND WOUND CORE PRODUCTION DEVICE

(71) Applicant: NIPPON STEEL CORPORATION, Tokyo (JP)

(72) Inventors: Takahito MIZUMURA, Tokyo (JP); Hisashi MOGI, Tokyo (JP); Masato MIZOKAMI, Tokyo (JP); Masaru TAKAHASHI, Tokyo (JP)

(73) Assignee: NIPPON STEEL CORPORATION, Tokyo (JP)

(21) Appl. No.: 18/032,887

(22) PCT Filed: Oct. 26, 2021
(86) PCT No.: PCT/JP2021/039557

§ 371 Date: Apr. 20, 2023

(30) Foreign Application Priority Data
Oct. 26, 2020 (JP) 2020-178562

(51) Int. Cl. H01F 41/02; H01F 27/245

(52) U.S. Cl. CPC H01F 41/024; H01F 27/2455

(57) ABSTRACT

A wound core (10) is a wound core having a wound shape (10) including a rectangular hollow portion (15) in a center and a portion in which grain-oriented electrical steel sheets (1) in which planar portions (4) and bent portions (5) are alternately continuous in a longitudinal direction are stacked in a sheet thickness direction, which is a wound core formed by stacking the grain-oriented electrical steel sheets(1) that have been individually bent in layers and assembled into a wound shape and in which the plurality of grain-oriented electrical steel sheets are connected to each other via at least one joining part (6) for each roll, wherein the bent portion (5) of the laminated grain-oriented electrical steel sheet (1) has an average Vickers hardness of 190 to 250 HV in an L cross section in the longitudinal direction which is a cross section of the grain-oriented electrical steel sheet (1) in a thickness direction.

### TECHNICAL FIELD

The present invention relates to a wound core, a method of producing a wound core and a wound core production device. Priority is claimed on Japanese Patent Application. No. 2020-178562, filed Oct. 26, 2020, the content of which is incorporated herein by reference.

### BACKGROUND ART

Transformer iron, cores include stacked iron cores and wound cores. Among these, the wound core is generally produced by stacking grain-oriented electrical steel sheets in layers, winding them in a donut shape (wound shape), and then pressing the wound body to mold it into substantially a rectangular shape (in this specification, a wound core produced in this manner may be referred to as a trunk core). According to this molding process, mechanical processing strain (plastic deformation strain) is applied to all of the grain-oriented electrical steel sheets, and the processing strain is a factor that greatly deteriorates the iron loss of the grain-oriented electrical steel sheet so that it is necessary to perform strain relief annealing.

On the other hand, as another method of producing a wound core, techniques such as those found in Patent Documents 1 to 3 in which portions of steel sheets that become corner portions of a wound core are bent in advance so that a relatively small bending area with a radius of curvature of 3 mm or less is formed and the bent steel sheets are laminated to form a wound core are disclosed (in this specification, the wound core produced in this manner may be referred to as Unicore (registered trademark)). According to this production method, a conventional large-scale molding process is not required, the steel sheet is precisely bent to maintain the shape of the iron core, and processing strain is concentrated only in the bent portion (corner) so that it is possible to omit strain removal according to the above annealing process, and its industrial advantages are great and its application is progressing.

### CITATION LIST

[Patent Document]

[Patent Document 1]
Japanese Unexamined Patent Application, First Publication No. 2005-286169

[Patent Document 2]
Japanese Patent No. 6224468

[Patent Document 3]
Japanese Unexamined Patent Application, First Publication No. 2018-148036

### SUMMARY OF THE INVENTION

### Problems to be Solved by the Invention

Incidentally, when the portion of the steel sheet that becomes a corner portion of a Unicore is bent by steel sheet bending, strain is introduced into the bent portion. Due to this strain, there is a problem of core iron loss becoming inferior when the core is used without being annealed. In addition, even if the core is annealed and used, depending on annealing conditions, the introduced strain may not be completely released, and there is also a risk of the core iron loss becoming inferior. For example, in Patent Document 3, the amount of plastic strain introduced is not sufficiently controlled. Therefore, in the method described in Patent Document 3, there is a risk of iron loss deteriorating.

The present invention has been made in view of the above circumstances, and an object of the present invention is to provide a wound core with low iron loss regardless of whether annealing is performed, a method of producing a wound core, and a wound core production device.

### Means for Solving the Problem

In order to achieve the above object, the present invention provides a wound core having a wound shape including a rectangular hollow portion in the center and a portion in which grain-oriented electrical steel sheets in which planar portions and bent portions are alternately continuous in a longitudinal direction are stacked in a sheet thickness direction, which is a wound core formed by stacking the grain-oriented electrical steel sheets that have been individually bent in layers and assembled into a wound shape and in which the plurality of grain-oriented electrical steel sheets are connected to each other via at least one joining part for each roll, in which any one or more of the arbitrary bent portions among the laminated grain-oriented electrical steel sheets have an average Vickers hardness of 190 to 250 HV in an L cross section in the longitudinal direction which is a cross section of the grain-oriented electrical steel sheet in a thickness direction.

The inventors have taken into account the fact that, in a Unicore type wound core, when a portion of a steel sheet that becomes a corner portion of a Unicore is bent by steel sheet bending, strain is introduced into a bent portion, and the core iron loss becomes inferior due to this strain, focused on the fact that, when a bent portion is formed by bending a steel sheet, the amount of plastic strain introduced into the bent portion is controlled to be within a predetermined range, and thereby a wound core with low iron loss is obtained, and found that, if the average Vickers, hardness in an L cross section of the bent portion after bending is within a range of 190 to 250 HV, the amount of plastic strain introduced into the bent portion is reduced to be within a predetermined range, and a wound core with low iron loss can be realized regardless of whether annealing is performed.

In order to achieve the average Vickers hardness within a range of 190 to 250 HV after bending at the bent portion, in steel sheet bending using a bending tool, it is effective control two parameters the tensile stress during steel sheet processing and the dynamic friction coefficient between the steel sheet and the bending tool. Specifically, for example, regarding the bent portion of the laminated grain-oriented electrical steel sheets,
(1) the tensile stress applied to the steel sheet in the longitudinal direction (L direction) during steel sheet processing is set to 0.8 MPa or more and 6.8 MPa or less (for example, the grain-oriented electrical steel sheet is bent while applying a tensile stress in a range of 0.8 MPa or more and 6.8 MPa or less to the grain-oriented electrical steel sheet in the longitudinal direction), and
(2) the dynamic friction coefficient between the steel sheet and the bending tool is set to 0.10 or more and 0.74 or less.
   if both of these settings are performed at the same time in combination,
   it is possible to effectively, easily, and reliably achieve an average Vickers hardness within a range of 190 to 250 HV, and accordingly, even if the core is used without being annealed, it is possible to obtain a core with little iron loss deterioration and if the core is annealed, it is possible to obtain a core with little residual strain.

In the above configuration, for example, arbitrary 10 points may be selected as positions in the L cross section of the bent portion at which the Vickers hardness is measured. The positions in the L cross section of the bent portion at which the Vickers hardness is measured are preferably separated from the surface, of the steel sheet by a predetermined distance in the steel sheet thickness direction. The position in the L cross section of the bent portion at which the Vickers hardness is measured is more preferably substantially the center of the steel sheet in the thickness direction. In addition, the measurement points are preferably separated from each other by a predetermined distance in the longitudinal direction of the steel sheet.

In addition, the present invention provides a method of producing a wound core and a production device which have the above features.

### Effects of the Invention

According to the present invention, since the average Vickers hardness in the L cross section of the bent portion after bending is within a range of 190 to 250 HV, the amount of plastic strain introduced into the bent portion is reduced to be within a predetermined range, regardless of whether annealing is performed, a wound core with low iron loss, a method of producing a wound core, and a wound core production device can be realized.

### BRIEF DESCRIPTION OF DRAWINGS

FIG. 1 is a perspective view schematically showing a wound core according to one embodiment of the present invention.

FIG. 2 is a side view of the wound core shown in the embodiment of FIG. 1.

FIG. 3 is a side view schematically showing a wound core according to another embodiment of the present invention.

FIG. 4 is a side view schematically showing an example of a single-layer grain oriented electrical steel sheet constituting a wound core.

FIG. 5 is a side view schematically showing another example of the single-layer grain-oriented electrical steel sheet constituting the wound core.

FIG. 6 is a side view schematically showing an example of a bent portion of the grain-oriented electrical steel sheet constituting the wound core of the present invention.

FIG. 7 is a schematic perspective view showing an example of a device for realizing bending in which a steel sheet is bent while applying tensile stress to the entire end surface, of the steel sheet to be bent in a longitudinal direction.

FIG. 8 is a diagram showing an example of a method of measuring a Vickers hardness at arbitrary 10 points on an L cross section of a bent portion.

FIG. 9 is a block diagram schematically showing a configuration of a Unicore type wound core production device.

FIG. 10 is a schematic view showing sizes of a wound core produced when properties are evaluated.

### EMBODIMENT(S) FOR IMPLEMENTING THE INVENTION

Hereinafter, a wound core according to one embodiment of the present invention will be described in detail in order. However, the present invention is not limited to only the configuration disclosed in the present embodiment, and can be variously modified without departing from the gist of the present invention. Here, lower limit values and upper limit values are included in the numerical value limiting ranges described below. Numerical values indicated by “more than” or “less than” are not included in these numerical value ranges. In addition, unless otherwise specified “%” relating to the chemical composition means “mass %.”

In addition, terms such as “parallel,” “perpendicular,” “identical,” and “right angle” and length and angle values used in this specification to specify shapes, geometric conditions and their extents are not bound by strict meanings, and should be interpreted to include the extent to which similar functions can be expected.

In addition, in this specification, “grain-oriented electrical steel sheet” may be simply described as “steel sheet” or “electrical steel sheet,” and “wound core” may be simply described as “iron core.”

The wound core according to one embodiment of the present invention is a wound core including a substantially rectangular wound core main body in a side view, and the wound core main body includes a portion in which grain-oriented electrical steel sheets in which planar portions and bent portions are alternately continuous in the longitudinal direction are stacked in a sheet thickness direction and has a substantially polygonal laminated structure in a side view. Here, the planar portion is a straight portion other than the bent portion. The inner radius of curvature r of the bent portion in a side view is, for example, 1.0 mm or more and 5.0 mm or less. As an example, the grain-oriented electrical steel sheet has a chemical composition containing, in mass %, Si: 2.0 to 7.0%, with the remainder being Fe and impurities, and has a texture oriented in the Goss orientation. As the grain-oriented electrical steel sheet, for example, a grain-oriented electromagnetic steel band described in JIS C 2553: 2019 can be used.

Next, the shapes of the wound core and the grain-oriented electrical steel sheet according to one embodiment of the present invention will be described in detail. The shapes themselves of the wound core and the grain-oriented electrical steel sheet described here are not particularly new, and merely correspond to the shapes of known wound cores and grain-oriented electrical steel sheets.

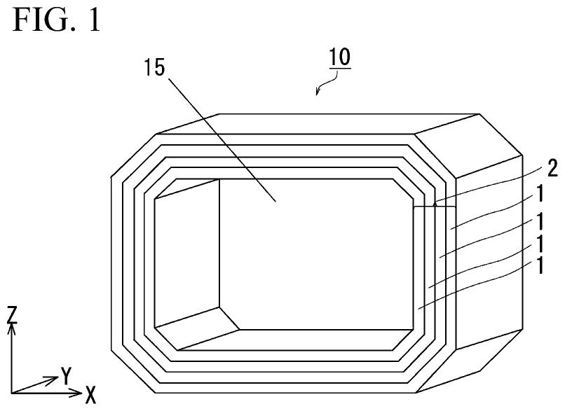

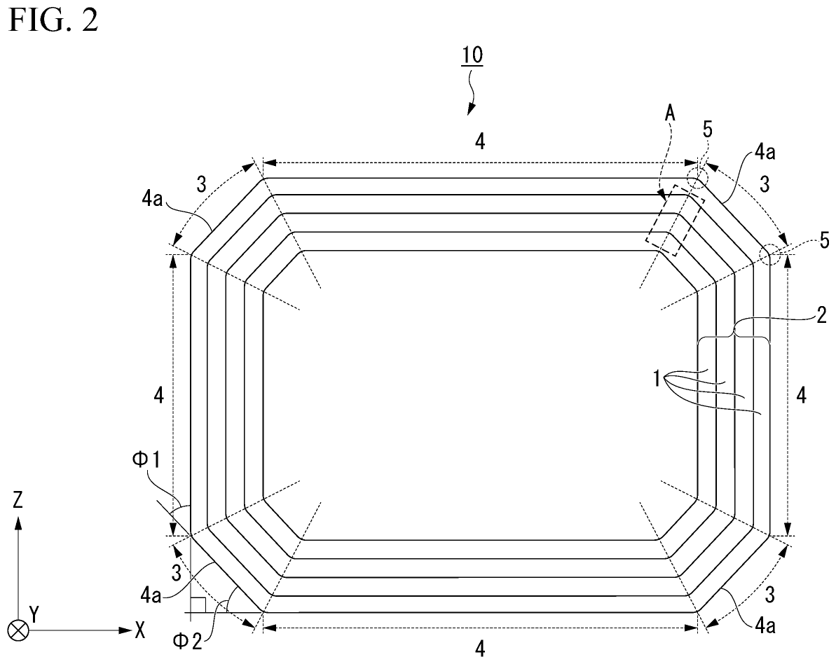

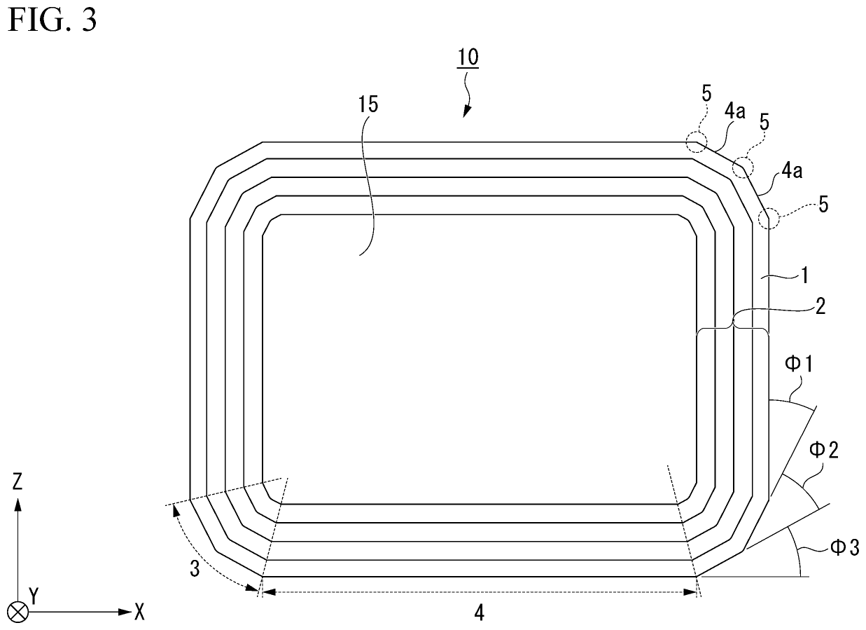

FIG. 1 is a perspective view schematically showing a wound core according to one embodiment. FIG. 2 is a side view of the wound core shown in the embodiment of FIG. 1. In addition, FIG. 3 is a side view schematically showing another embodiment of the wound core.

Here, in the present invention, the side view is a view of the long-shaped grain-oriented electrical steel sheet constituting the wound core in the width direction (Y-axis direction in FIG. 1). The side view is a view showing, a shape visible from, the side (a view in the Y-axis direction in FIG. 1).

A wound core 10 according to one embodiment of the present invention includes a substantially polygonal wound core, main body in a side view. The wound core main body 10 has a substantially rectangular laminated structure in a side view in which grain-oriented electrical steel sheets 1 are stacked in a sheet thickness direction. The wound core main body 10 may be used as a wound core without change, or may include, as necessary, for example, a known fastener such as a binding band for integrally fixing a plurality of stacked grain-oriented electrical steel sheets.

In the present embodiment, the iron core length of the wound core main body 10 is not particularly limited. If the number of bent portions 5 is the same, even if the iron core length of the wound core 10 changes, the volume of the bent portion 5 is constant so that the iron loss generated in the bent portion 5 is constant. If the iron core length is longer, the volume ratio of the bent portion 5 to the wound core main body 10 is smaller and the influence on iron loss deterioration is also small. Therefore, a longer iron core length of the wound core main body 10 is preferable. The iron core length of the wound core main body 10 is preferably 1.5 m or more and more preferably 1.7 m or more. Here, in the present invention, the iron core length of the wound core main body 10 is the circumferential length at the central point in the laminating direction of the wound core main body 10 in a side view.

Such a wound core can be suitably used for any conventionally known application.

The iron core according to the present embodiment has substantially a polygonal shape in a side view. In the description using the following drawings, for simplicity of illustration and description, a substantially rectangular (square) iron core, which is a general shape, will be described, but iron cores having various shapes can be produced depending on the angle and number of bent portions 5 and the length of the planar portion. For example, if the angles of all the bent portions 5 are 45° and the lengths of the planar portions 4 are equal, the side view is octagonal. In addition, if the angle is 60°, there are six bent portions 5, and the lengths of the planar portions 4 are equal, the side view is hexagonal.

As shown in FIG. 1 and FIG. 2, the wound core main body 10 includes a portion in which the grain-oriented electrical steel sheets 1 in which the planar portions 4 and 4a and the bent portions 5 are alternately continuous in the longitudinal direction are stacked in a sheet thickness direction and has a substantially rectangular laminated structure 2 having a hollow portion 15 in a side view. A corner portion 3 including the bent portion has two or more bent portions 5 having a curved shape in a side view, and the sum of the bent angles of the bent portions 5 present in one corner portion 3 is, for example, 90°. The corner portion 3 has a planar portion 4a shorter than the planar portion 4 between the adjacent bent portions 5 and 5. Therefore, the corner portion 3 has a form including two or more bent portions 5 and one or more planar portions 4a. Here, in the embodiment of FIG. 2, one bent portion 5 has an angle of 45°. In the embodiment of FIG. 3, one bent portion 5 has an angle of 30°.

As shown in these examples, the wound core of the present embodiment can be formed with bent portions having various angles, but in order to minimize the occurrence of distortion due to deformation during processing and minimize the iron loss, the bent angle φ (φ1, φ2, φ3) of the bent portion 5 is preferably 60° or less and more preferably 45° or less. The bent angle φ of the bent portion of one iron core can be arbitrarily formed. For example, φ1=60° and φ2=30° can be set. It is preferable that folding angles (bent angles) be equal in consideration of production efficiency, and when the iron loss of the iron core generated according to the iron loss of the steel sheet used can be reduced if deformed portions equal to or larger than a certain size can be reduced, processing may be performed with a combination of different angles. The design can be arbitrarily selected from points that are emphasized in iron core processing.

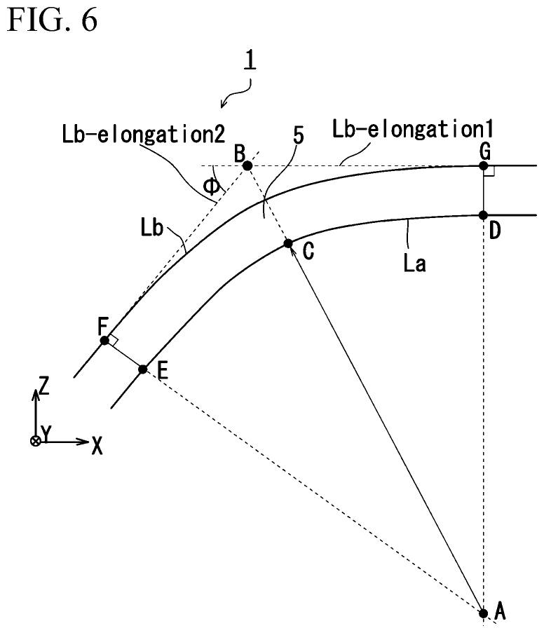

The bent portion 5 will be described in more detail with reference to FIG. 6. FIG. 6 is a diagram schematically showing an example of the bent portion (curved portion) 5 of the grain-oriented electrical steel sheet 1. The bent angle of the bent portion 5 is the angle difference occurring between the rear straight portion and the front straight portion in the bending direction at the bent portion of the grain-oriented electrical steel sheet, and is expressed, on the outer surface of the grain-oriented electrical steel sheet 1, as an angle φ that is a supplementary angle of the angle formed by two virtual lines Lb-elongation1 and Lb-elongation2 obtained by extending the straight portions that are surfaces of the planar portions 4 and 4a on both sides across the bent portion 5. In this case, the point at which the extended straight line separates from the surface of the steel sheet is the boundary between the planar portion 4 and the bent portion 5 on the outer surface of the steel sheet, which is the point F and the point G in FIG. 6.

In addition, straight lines perpendicular to the outer surface of the steel sheet extend from the point F and the point G and intersections with the inner surface of the steel sheet are the point E and the point D. The point E and the point D are the boundaries between the planar portion 4 and the bent portion 5 on the inner surface of the steel sheet.

Here, in the present invention, the bent portion 5 is a portion of the grain-oriented electrical steel sheet 1 surrounded by the point D, the point E, the point F, and the point G in a side view of the grain-oriented electrical steel sheet 1. In FIG. 6, the surface of the steel sheet between the point D and the point E, that is, the inner surface of the bent portion 5, is indicated by La, and the surface of the steel sheet between the point F and the point G, that is, the outer surface of the bent portion 5, is indicated by Lb.

In addition, this drawing shows the inner radius of curvature r of the bent portion 5 in a side view. The radius of curvature r of the bent portion 5 is obtained by approximating the above La with an are passing through the point E and the point D. A smaller radius of curvature r indicates a sharper curvature of the curved portion of the bent portion 5, and a larger radius of curvature r indicates a gentler curvature of the curved portion of the bent portion 5.

In the wound core of the present invention, the radius of curvature r at each bent portion 5 of the grain-oriented electrical steel sheets 1 laminated in the sheet thickness direction may vary to some extent. This variation may be a variation due to molding accuracy, and it is conceivable that an unintended variation may occur due to handling during lamination. Such an unintended error can be minimized to about 0.2 mm or less in current general industrial production. If such a variation is large, a representative value can be obtained by measuring the curvature radii of a sufficiently large number of steel sheets and averaging them. In addition, it is conceivable to change it intentionally for some reason, and the present invention does not exclude such a form. The radius of curvature (the inner radius of curvature of the bent portion 5 in a side view) r of the bent portion 5 is preferably 1 mm or more and 5 mm or less. When the radius of curvature r is set to 1 mm or more and 5 mm or less, it is possible to further minimize the building factor (BF).

Here, the method of measuring the radius of curvature r of the bent portion 5 is not particularly limited, and for example, the radius of curvature r can be measured by performing observation using a commercially available microscope (Nikon ECLIPSE LV150) at a magnification of 200. Specifically, the curvature center point A is obtained from the observation result, and for a method of obtaining this, for example, if the intersection of the line segment EF and the line segment DG extended inward on the side opposite to the point B is defined as A, the magnitude of the radius of curvature r corresponds to the length of the line segment AC. Here, when, the point A and the point B are connected by a straight line, the intersection on an arc DE inside the bent portion of the steel sheet is C.

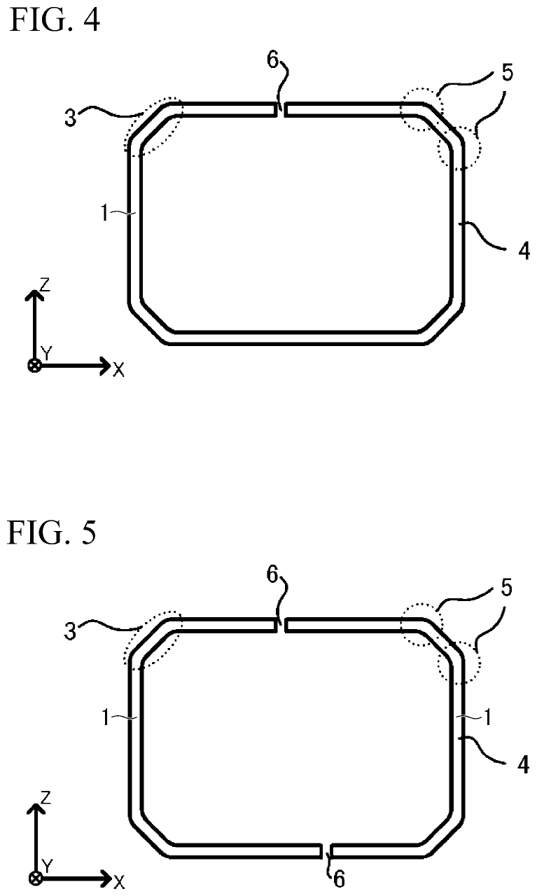

FIG. 4 and FIG. 5 are diagrams schematically showing, an example of a single-layer grain-oriented electrical steel sheet 1 in a wound core main body. The grain oriented electrical steel sheet 1 used in the examples of FIG. 4 and FIG. 5 is bent to realize a Unicore type wound core, and includes two or more bent portions 5 and the planar portion 4, and forms a substantially polygonal ring in a side view via a joining part 6 (gap) that is an end surface of one or more grain-oriented electrical steel sheets 1 in the longitudinal direction.

In the present embodiment, the entire wound core main body 10 may have a substantially polygonal, laminated structure in a side view. As shown in the example of FIG. 4, one grain-oriented electrical steel sheet may form one layer of the wound core main body via one joining part 6 (one grain-oriented electrical steel sheet is connected via one joining part 6 for each roll), and as shown in the example of FIG. 5, one grain oriented electrical steel sheet 1 may form about half the circumference of the wound core, and two grain-oriented electrical steel sheets 1 may form one layer of the wound core main body via two joining parts 6 (two grain-oriented electrical steel sheets 1 are connected to each, other via two joining parts 6 for each roll).

The sheet thickness of the grain-oriented electrical steel sheet 1 used in the present embodiment is not particularly limited, and may be appropriately selected according to applications and the like, but is generally within a range of 0.15 mm to 0.35 mm and preferably in a range of 0.18 mm to 0.27 mm.

In addition, the method of producing the grain-oriented electrical steel sheet is not particularly limited, and a conventionally known method of producing a grain-oriented electrical, steel sheet can be appropriately selected. Specific examples of a preferable production method include, for example, a method in which a slab containing 0.04 to 0.1 mass % of C, with the remainder being the chemical composition of the grain-oriented electrical steel sheet, is heated to 1,000° C. or higher and hot-rolled sheet annealing is then performed as necessary, and a cold-rolled steel sheet is then obtained by cold-rolling once, twice or more with intermediate annealing, the cold-rolled steel sheet is heated, decarburized and annealed, for example, at 700 to 900° C. in, a wet hydrogen-inert gas atmosphere, and as necessary, nitridation annealing is additionally performed, an annealing separator is applied, finish annealing is then performed at about 1,000° C., and an, insulating coating is formed at about 900° C. In addition, after that, a coating or the like for adjusting the dynamic friction coefficient may be implemented.

In addition, generally, the effects of the present invention can be obtained even with a steel sheet that has been subjected to a treatment called “magnetic domain control” using strain, grooves or the like in the steel sheet producing process by a known method.

In addition, in the present embodiment, the wound core composed of the grain-oriented electrical steel sheet 1 having the above form is formed by stacking the grain-oriented electrical steel sheets 1 that have been individually bent in layers and assembled into a wound shape, a plurality of grain-oriented electrical steel sheets 1 are connected to, each other via at least one joining part 6 for each roll, and the bent portion 5 of the laminated grain-oriented electrical steel sheet 1 has an average Vickers hardness of 190 to 250 HV in an L cross section (a cross section obtained by cutting a portion of the grain-oriented electrical steel sheet 1 surrounded by the point D, the point E, the point F, and the point G FIG. 6 in a plane parallel to the plane in FIG. 6) in the longitudinal direction which is a cross section of the grain-oriented electrical steel sheet 1 in the thickness direction (Z-axis direction in the drawing). Between the grain-oriented electrical steel sheets 1, the variation in the Vickers hardness of the bent portion 5 is small. Therefore, when the average Vickers hardness is measured, any one grain oriented electrical steel sheet may be selected and measured, and for example, three grain-oriented electrical steel sheets may be selected and measured, and the average of these measurement values may be used. In addition, since the bent portion 5 of the grain-oriented electrical steel sheet has a small variation, arbitrary bent portions 5 may be selected, the average value thereof may be used as the average Vickers hardness, and the average value of the plurality of bent portions 5 may be used. Here, the Vickers hardness is measured according to JIS Z 2244 (2009). A measurement load is 25 gf.

In addition, the average Vickers hardness of the planar portion 4 and the average Vickers hardness of the bent portion 5 are preferably 200 HV to 225 HV. For the average Vickers hardness of the planar portion 4, in measurement of the Vickers hardness of the bent portion 5, “bent portion” is replaced with “planar portion.”

The absolute value of the difference between the average Vickers hardness of the planar portion 4 and the average Vickers hardness of the bent portion 5 is preferably 50 HV or less. The absolute value of the difference between the average Vickers hardness of the planar portion 4 and the average Vickers hardness of the bent portion 5 is more preferably 40 HV or less. If the absolute value of the difference between the average Vickers hardness of the planar portion 4 and the average Vickers hardness of the bent portion 5 is 50 HV or less, it is possible to further minimize the building factor (BF).

In order to achieve an average Vickers hardness within a range of 190 to 250 HV after bending at the bent portion 5, in the present embodiment, in steel sheet bending using a bending tool (punch), both parameters (control factors), the tensile stress during steel sheet processing, and the dynamic friction coefficient between the steel sheet 1 and the bending tool are controlled to be within a predetermined range. Specifically, in the present embodiment, regarding steel sheet bending in which any one or more arbitrary bent portions 5 of the laminated grain-oriented electrical steel sheets 1 are formed, a bending process is controlled so that the tensile stress during steel sheet processing is in a range of 0.8 MPa or more and 6.8 MPa or less and the dynamic friction coefficient between the grain-oriented electrical steel sheet 1 and the bending tool is in a range of 0.10 or more and 0.74 or less. The tensile stress is more preferably 2.2 MPa or more and 4.3 MPa or less. The dynamic friction coefficient is more preferably 0.3 to 0.44. Hereinafter, a device for realizing such bending will be simply described. Here, for the dynamic friction coefficient, two samples, a material plate and a steel sheet, with the same roughness as the surface of the punch, are brought into contact with each other and left, a weight is placed as a test load, a drawing string is attached to the upper sample and slides it, and a resistance force (frictional force) generated at that time is measured with a load cell.

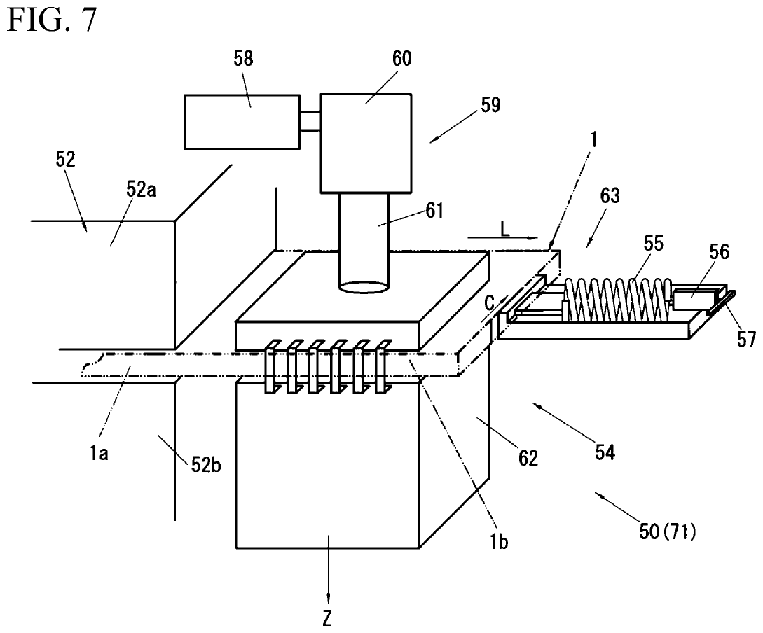

Bending performed while applying a tensile stress in a range of 0.8 MPa or more and 6.8 MPa or less in a longitudinal direction L to the entire end surface (C cross section) perpendicular to the steel sheet to be bent in the longitudinal direction is performed by, for example, a bending unit 71 including a device (bending tool) 50 as shown in FIG. 7. The device 50 shown in FIG. 7 includes a steel sheet holding unit 52 that holds and fixes one side portion 1a of the grain-oriented electrical steel sheet 1, for example, in a holding state, and a bending mechanism 54 for performing bending in a direction Z perpendicular to the longitudinal direction L and the width direction C while holding other side end 1b of the grain-oriented electrical steel sheet 1 to be bent and applying tensile stress to the end surface of the other side end 1b in the longitudinal direction L. Specifically, the bending mechanism 54 includes a holding portion 62 that holds the other side end 1b of the grain-oriented electrical steel sheet 1, for example, in the direction Z perpendicular to the longitudinal direction. L and the width direction C in a clamping manner, a tensile stress applying unit 63 that is provided on one side of the holding portion 62 in the longitudinal direction L and applies a tensile stress in a range of 0.8 MPa or more and 6.8 MPa or less to the other side end 1b of the grain-oriented electrical steel sheet 1 held by the holding portion 62 in the longitudinal direction L, and a bent portion forming portion 59 that presses down the holding portion 62 in the Z direction, bends the other side end 1b of the grain-oriented electrical steel sheet 1 held by the holding, portion 62, for example, at a punch speed of 20 min/sec or more and 80 mm/sec or less, and forms the bent, portion 5. When the dynamic friction coefficient and the tensile stress are appropriately controlled and the punch speed is set to 20 mm/sec or more and 80 mm/sec or less, the absolute value of the difference between the Vickers hardness of the planar portion 4 and the Vickers hardness of the bent portion 5 can be 50 HV or less. The tensile stress applying unit 63 can control tensile stress by a load meter 56 using a spring 55 and can set a load by a handle 57. In addition, the bent portion forming portion 59 includes a servo motor 58, a pump 60 that is driven by the servo motor 58, and an elevating portion 61 that is connected to the upper end of the holding portion 62, and the holding portion 62 can be moved in, the Z direction by raising and lowering the elevating portion 61 with the pressure, generated by the pump 60.

In addition, in bending using such a device 50, in order for the dynamic friction coefficient between the steel sheet 1 and the device 50 (bending tool) to be in a range of 0.10 or more and 0.74 or less, for example, the roughness of the surface of an upper die 52a and a lower die 52b, which constitute the steel sheet holding unit 52, and with the one side portion 1a of the grain-oriented electrical steel sheet 1 interposed therebetween from the upper and lower sides, is set so that the dynamic friction coefficient is in a range of 0.10 or more and 0.74 or less, or a layer made of an oil or the like is attached to the surface of the upper die 52a and the lower die 52b (the thickness of the oil film changes) so that the dynamic friction coefficient is in a range of 0.10 or more and 0.74 or less. Here, generally, the dynamic friction coefficient between, the grain-oriented electrical steel sheet 1 and the bending tool is 0.03 or less.

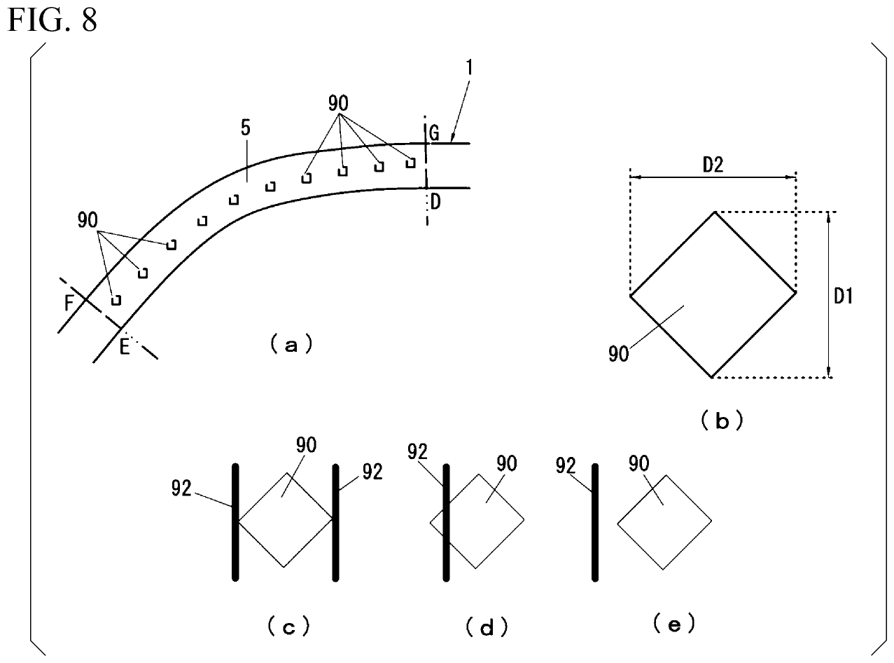

Next, an example of measuring the Vickers hardness in the L cross section of the bent portion 5 of the grain-oriented electrical steel sheet 1 obtained using the above device 50 will be described with reference to FIG. 8.

In measurement of the Vickers hardness of the bent portion 5 of the grain-oriented electrical steel sheet 1, as shown in FIG. 8(a), in an illustrated L cross section in, the longitudinal direction L which is a cross section of the grain-oriented electrical steel sheet in a thickness direction 1, the Vickers hardness is measured at 10 arbitrary points. Specifically, during measurement, 10 approximately square indentations (hardness evaluation point; arbitrary point) 90 obtained by pressing a rigid indenter into the cross section of the grain-oriented electrical steel sheet 1 are formed in the longitudinal direction of the bent portion 5, two diagonal lengths D1 and D2 of the approximately square indentation 90 shown in FIG. 8(b) are measured, the average value thereof is defined as the diagonal length D of the indentation 90, and based on the length D of the diagonal line, the Vickers hardness at the indentation 90 is calculated by a well-known method. For example, in the present embodiment, the Vickers hardness is measured using HM-221 (Mitutoyo Corporation) as a hardness evaluation device. Here, the test force, which is a load that presses the indenter, is set to 25 gf, and the position of the indentation 90, which is the hardness evaluation point, is preferably separated from, the surface of the steel sheet by a predetermined distance in the steel sheet thickness direction (at least 2.5 D inside from the surface of the steel sheet). In addition, the position of the indentation 90 is more preferably the center in the steel sheet thickness direction. In addition, the indentations 90 are preferably separated by a predetermined distance (at least 2.5 D) in the longitudinal direction of the steel sheet (preferably at equal intervals). Thus, in the present embodiment, the average value of the Vickers hardnesses at these 10 indentations 90 needs to be 190 to 250 HV.

Here, in evaluation of the diagonal lengths D1 and D2 in the analysis using HM-221 (Mitutoyo Corporation) after 10 indentations 90 are plotted, as shown in FIG. 8(c), the indentation 90 is brought into contact with the inside, of an evaluation line 92. That is, as shown in FIG. 8(d), a part of the indentation 90 does not protrude outside the evaluation line 92, or as shown in FIG. 8(e), the indentation 90 should not be too far inward from the evaluation line 92.

Here, regarding a method of preparing a sample for measurement of a cross section of the bent portion 5, the wound core 10 according to the present embodiment will be exemplified.

A sample for measurement of a cross section of the bent portion 5 is collected from the vicinity of the corner, portion 3 (a region A shown in FIG. 2) of the grain-oriented electrical steel sheet 1 constituting the wound core 10. From the region A, a sample including the bent portion 5 is collected using a shearing machine. In this case, the clearance from the shearing blade is set to about 0.1 to 2 mm, and the bent portion 5 is sheared so that the sheared cross section does not cross. In addition, since it is difficult to shear the grain-oriented electrical steel sheets 1 which are stacked bent components, at once, the sheets are sheared one by one. Next, while members that have been sheared one by one are stacked, one side in the sheet width is embedded with an epoxy resin, and the embedded surface is polished. In polishing, after changing the SiC polishing paper from JIS R 6010 grain size polishing paper #80 to #220, #600, #1000, #1500, 6 μm, 3 μm, or 1 μm diamond polishing is performed to achieve a mirror finish. Finally, in order to corrode the structure, the structure is immersed in a solution obtained by adding 2 to 3 drops of picric acid and hydrochloric acid to 3% nital for just under 20 seconds and corroded to obtain a sample for measurement of a cross section of the bent portion 5.

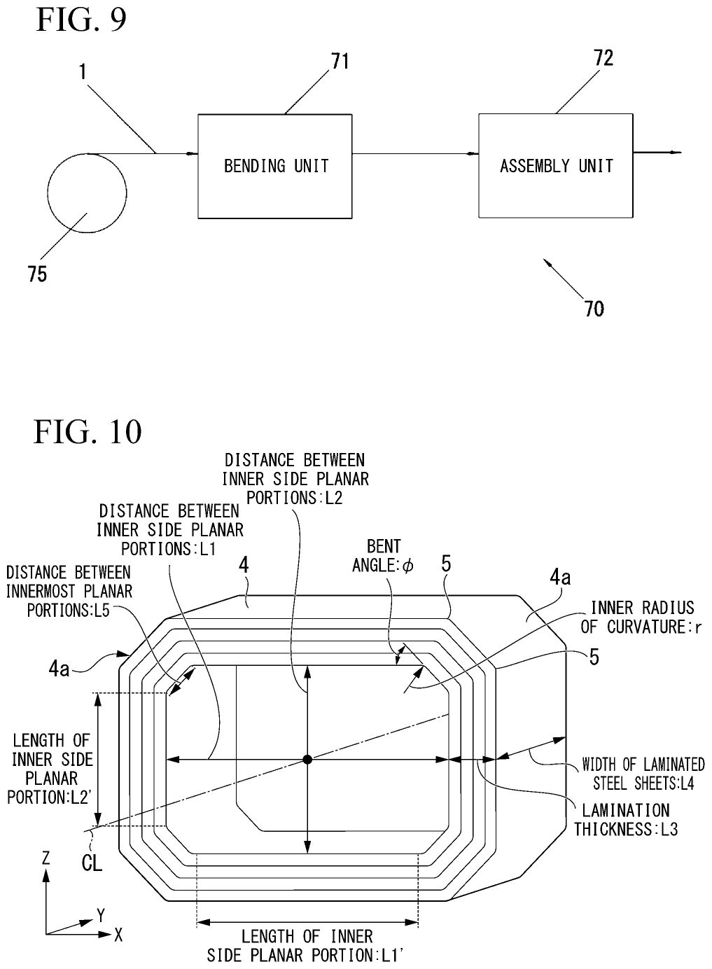

In addition, FIG. 9 schematically shows a block diagram of a device that can produce a wound core involving steel sheet bending as described above. FIG. 9 schematically shows a production device 70 for a Unicore type wound core, and the production device 70 includes the bending unit 71 that individually bends the grain-oriented electrical steel sheets 1 and may include an assembly unit 72 that stacks the bent grain-oriented electrical steel sheets 1 in layers and assembles them into a wound shape to form a wound core having a wound shape including a portion in which the grain-oriented electrical steel sheets 1 in which the planar portions 4 and the bent portions 5 are alternately continuous in the longitudinal direction are stacked in a sheet thickness direction.

The grain-oriented electrical steel sheets 1 are fed at a predetermined conveying speed from a steel sheet supply unit 75 that holds a hoop member formed by winding the grain-oriented electrical steel sheet 1 in a roll shape and supplied to the bending unit 71. The grain-oriented electrical steel sheets 1 supplied in this manner are appropriately cut to an appropriate size in the bending unit 71 and subjected to bending in which a small number of sheets are individually bent such as one sheet at a time. In the grain-oriented electrical steel sheet 1 obtained in this manner, since the radius of curvature of the bent portion 5 caused by bending is very small, the processing strain applied to the grain-oriented electrical steel sheet 1 by bending is very small. In this manner, while the density of the processing strain is expected to increase, if the volume influenced by the processing strain can be reduced, the annealing process can be omitted.

In addition, the bending unit 71 includes the above device 50, controls bending so that the tensile stress during steel sheet processing is in a range of 0.8 MPa or more and 6.8 MPa or less and the dynamic friction coefficient between the steel sheet 1 and the bending tool is in, a range of 0.10 or more and 0.74 or less, and forms any one or more arbitrary bent portions 5 of the laminated grain-oriented electrical steel sheets 1.

Next, data verifying that the iron loss is minimized with the wound core 10 having the above configuration according to the present embodiment is shown below.

The inventors produced iron cores a to f having shapes shown in Table 1 and FIG. 10 using respective steel sheets as materials when acquiring the verification data.

Here, L1 is parallel to the X-axis direction and is a distance between parallel grain-oriented electrical steel sheets 1 on the innermost periphery of the wound core in a flat cross section including the center CL (a distance between inner side planar portions), L2 is parallel to the Z-axis direction and is a distance between parallel, grain-oriented electrical steel sheets 1 on the innermost periphery of the wound core in a vertical cross section including the center CL (a distance between inner side planar portions). L3 is parallel to the X-axis direction and is a lamination thickness of the wound core in a flat cross section including the center CL (a thickness in the laminating direction). L4 is parallel to the X-axis direction and is a width of the laminated steel sheets of the wound core in a flat cross section including the center CL. L5 is a distance between planar portions that are adjacent, to each other in the innermost portion of the wound core and arranged to form a right angle together (a distance between bent portions). In other words, L5 is a length of the planar portion 4a in the longitudinal direction which has the shortest length among the planar portions 4 and 4a of the grain-oriented electrical steel sheets on the innermost periphery. r is the radius of curvature of the bent portion 5 on the innermost peripheral side of the wound core. φ is the bent angle of the bent portion of the wound core. The cores Nos. a to f of the substantially rectangular iron cores in Table 1 have a structure in which a planar portion with an, inner side planar portion, distance of L1 is divided at approximately in the center of the distance L1 and two iron cores having “substantially a U-shape” are connected. The radius of curvature of the core e of the iron core increases toward the outside. Otherwise, the inner and outer curvature radii of the core are the same. In addition, the bent angle of the core e of the iron core is 90 degrees.

Here, the iron core of the core No. e is conventionally used as a general wound core, and is a so-called trunk core type wound core produced by a method of shearing a steel sheet, winding it into a cylindrical shape, then pressing the cylindrical laminated body without change, and forming it into substantially a rectangular shape. Therefore, the radius of curvature of the bent portion 5 of the wound core of the core No. e varies greatly depending on the lamination position of the steel sheet. Regarding, the iron core of the core No. e, in Table 1, * indicates that r increases toward the outside, r=5 mm at the innermost periphery part and r=60 mm at the outermost periphery part. In addition, the iron core of the core No. c is a Unicore type wound core having a larger radius of curvature r (the radius of curvature r exceeds 5 mm) than the iron cores of the cores Nos. a, b, d, and f (Unicore type wound core), and the iron core of the core No. d is a Unicore type wound core having three bent portions 5 at one corner portion 3.

TABLE 1

| | Core shape | | | | | | |
|---|---|---|---|---|---|---|---|
| Core | L1 | L2 | L3 | L4 | L5 | r | ϕ |
| No. | mm | mm | mm | mm | mm | mm | ° |
| a | 197 | 66 | 47 | 152.4 | 4 | 1 | 45 |
| b | 197 | 66 | 47 | 152.4 | 4 | 5 | 45 |
| c | 197 | 66 | 47 | 152.4 | 4 | 6 | 45 |
| d | 197 | 66 | 47 | 152.4 | 4 | 2 | 30 |
| e | 197 | 66 | 47 | 152.4 | 4 | * | 90 |
| f | 197 | 66 | 47 | 152.4 | 4 | 2 | 45 |

Table 2 to Table 10 show, based on various core shapes as described above, the Vickers hardness (HV) of the average at 10 points on the bent portion 5 described above obtained by measuring 204 example materials in which the target bent angle φ(°), the steel sheet thickness (mm), the tensile stress (MPa) applied to the steel sheet 1 in the longitudinal direction L, and the dynamic friction coefficient between the steel sheet 1 and the bending tool (the dies 52a and 52b of the device 50) were set for. In addition, the building factor (BF) was measured and evaluated based on the iron loss (W/kg) of the iron core and the iron loss (W/kg) of the steel sheet. Here, the Vickers hardness was measured at the center in the sheet thickness direction so that the indentations were separated from each other by a predetermined distance (the above 2.5D) in the longitudinal direction of the steel sheet at equal intervals. The load was 25 gf. For the Vickers hardness of the core e of the iron core, the Vickers hardnesses of the bent portions 5 collected from the outermost periphery and the innermost periphery of the iron core of the core No. e were measured, and an average value thereof was used. Similarly, for the Vickers hardness of the planar portion of the core e of the iron core, in the same manner as for the bent portion, the Vickers hardness was measured at the planar portions collected from the outermost periphery and the innermost periphery, and an average value thereof was used. The absolute value of the difference in the Vickers hardness between the bent portion and the planar portion was obtained from the difference between the measured average value of the Vickers hardness of the bent portion and the average value of the Vickers hardness of the planar portion.

In the measurement of the building factor, regarding the wound cores of the cores No. a to No. f in Table 1, measurement using an excitation current method described in JIS C 2550-1 was performed under conditions of a frequency of 50 Hz and a magnetic flux density of 1.7 T and the iron loss value (iron core iron loss) W_{A} of the wound core was measured. In addition, a sample with a width of 100 mm×a length of 50 mm was collected from the hoop (with a sheet width of 152.4 mm) of the grain-oriented electrical steel sheet used for the iron core, the sample was measured according to an electrical steel sheet, single magnetic property test using an H coil method described in JIS C 2556 under conditions of a frequency of 50 Hz and a magnetic flux density of 1.7 T, and the iron loss value (iron loss of the steel sheet)W_{B} of the material single steel sheet was measured. Then, a building factor (BF) was obtained by dividing the iron loss value W_{A} by the iron loss value W_{B}. A case with a BE of 1.15 or more was evaluated as D. A case with a BF of 1.13 or more and less than 1.15 was evaluated as C. A case with a BF of 1.05 or more and less than 1.13 was evaluated as B. A case with a BF of less than 1.05 was evaluated as A. The evaluation A or the evaluation B was determined to be satisfactory.

TABLE 2

| | | | | | | | | Absolute | | | | |
|---|---|---|---|---|---|---|---|---|---|---|---|---|
| | | | | | | | | value of | | | | |
| | | | | | | | | difference | | | | |
| | | | | | | | Average | in Vickers | | | | |
| | | | | | | | of Vickers | hardness | | | | |
| | | | | | Dynamic | | hardness | between | | | | |
| | | | | | friction | | in bent | bent | Iron | Iron | | |
| | | Target | Steel | | coefficient | | portion | portion | loss of | loss of | | |
| | | bent | sheet | Tensile | between | Punch | with | and planar | iron | steel | | |
| | Core | angle φ | thickness | stress | steel sheet | speed | n = 10 | portion | core | sheet | | |
| No. | No. | (°) | (mm) | (MPa) | and die 1 | (mm/sec) | (HV) | (HV) | (W/kg) | (W/kg) | BF | Result |
| 1 | a | 45 | 0.23 | 0 | 0.03 | 3 | 169 | 60 | 0.943 | 0.82 | 1.15 | D |
| 2 | a | 45 | 0.23 | 0.8 | 0.03 | 40 | 170 | 55 | 0.951 | 0.82 | 1.16 | D |
| 3 | a | 45 | 0.23 | 2.2 | 0.03 | 20 | 175 | 50 | 0.943 | 0.82 | 1.15 | D |
| 4 | a | 45 | 0.23 | 3.8 | 0.03 | 30 | 173 | 55 | 0.935 | 0.82 | 1.14 | C |
| 5 | a | 45 | 0.23 | 4.3 | 0.03 | 40 | 174 | 50 | 0.951 | 0.82 | 1.16 | D |
| 6 | a | 45 | 0.23 | 5.5 | 0.03 | 50 | 172 | 60 | 0.943 | 0.82 | 1.15 | D |
| 7 | a | 45 | 0.23 | 6.8 | 0.03 | 80 | 175 | 75 | 0.943 | 0.82 | 1.15 | D |
| 8 | a | 45 | 0.23 | 7.5 | 0.03 | 100 | 176 | 70 | 0.943 | 0.82 | 1.15 | D |
| 9 | a | 45 | 0.23 | 22 | 0.03 | 150 | 175 | 100 | 1.017 | 0.82 | 1.24 | D |
| 10 | a | 45 | 0.23 | 0.8 | 0.07 | 30 | 172 | 55 | 0.943 | 0.82 | 1.15 | D |
| 11 | a | 45 | 0.23 | 0.8 | 0.07 | 40 | 173 | 46 | 0.951 | 0.82 | 1.16 | D |
| 12 | a | 45 | 0.23 | 2.2 | 0.07 | 20 | 179 | 41 | 0.943 | 0.82 | 1.15 | D |
| 13 | a | 45 | 0.23 | 3.8 | 0.07 | 30 | 176 | 55 | 0.943 | 0.82 | 1.15 | D |
| 14 | a | 45 | 0.23 | 4.3 | 0.07 | 40 | 177 | 50 | 0.951 | 0.82 | 1.16 | D |
| 15 | a | 45 | 0.23 | 5.5 | 0.07 | 50 | 175 | 57 | 0.943 | 0.82 | 1.15 | D |
| 16 | a | 45 | 0.23 | 6.8 | 0.07 | 80 | 179 | 72 | 0.943 | 0.82 | 1.15 | D |
| 17 | a | 45 | 0.23 | 7.5 | 0.07 | 100 | 180 | 83 | 0.943 | 0.82 | 1.15 | D |
| 18 | a | 45 | 0.23 | 22 | 0.07 | 150 | 187 | 87 | 1.009 | 0.82 | 1.23 | D |
| 19 | a | 45 | 0.23 | 0 | 0.10 | 40 | 180 | 54 | 0.943 | 0.82 | 1.15 | D |
| 20 | a | 45 | 0.23 | 0.8 | 0.10 | 40 | 190 | 26 | 0.877 | 0.82 | 1.07 | B |
| 21 | a | 45 | 0.23 | 2.2 | 0.10 | 20 | 196 | 18 | 0.861 | 0.82 | 1.05 | B |
| 22 | a | 45 | 0.23 | 3.8 | 0.10 | 30 | 196 | 12 | 0.853 | 0.82 | 1.04 | A |
| 23 | a | 45 | 0.23 | 4.3 | 0.10 | 40 | 200 | 9 | 0.853 | 0.82 | 1.04 | A |

TABLE 3

| | | | | | | | | Absolute | | | | |
|---|---|---|---|---|---|---|---|---|---|---|---|---|
| | | | | | | | | value of | | | | |
| | | | | | | | | difference | | | | |
| | | | | | | | Average | in Vickers | | | | |
| | | | | | | | of Vickers | hardness | | | | |
| | | | | | Dynamic | | hardness | between | | | | |
| | | | | | friction | | in bent | bent | Iron | Iron | | |
| | | Target | Steel | | coefficient | | portion | portion | loss of | loss of | | |
| | | bent | sheet | Tensile | between | Punch | with | and planar | iron | steel | | |
| | Core | angle φ | thickness | stress | steel sheet | speed | n = 10 | portion | core | sheet | | |
| No. | No. | (°) | (mm) | (MPa) | and die 1 | (mm/sec) | (HV) | (HV) | (W/kg) | (W/kg) | BF | Result |
| 24 | a | 45 | 0.23 | 5.5 | 0.10 | 50 | 236 | 24 | 0.886 | 0.82 | 1.08 | B |
| 25 | a | 45 | 0.23 | 6.8 | 0.10 | 80 | 241 | 28 | 0.894 | 0.82 | 1.09 | B |
| 26 | a | 45 | 0.23 | 22 | 0.10 | 40 | 265 | 36 | 1.017 | 0.82 | 1.24 | D |
| 27 | a | 45 | 0.23 | 0 | 0.30 | 40 | 182 | 57 | 0.927 | 0.82 | 1.13 | D |
| 28 | a | 45 | 0.23 | 0.8 | 0.30 | 40 | 193 | 26 | 0.861 | 0.82 | 1.05 | B |
| 29 | a | 45 | 0.23 | 2.2 | 0.30 | 20 | 200 | 10 | 0.845 | 0.82 | 1.03 | A |
| 30 | a | 45 | 0.23 | 3.8 | 0.30 | 30 | 213 | 7 | 0.836 | 0.82 | 1.02 | A |
| 31 | a | 45 | 0.23 | 4.3 | 0.30 | 40 | 222 | 4 | 0.828 | 0.82 | 1.01 | A |
| 32 | a | 45 | 0.23 | 5.5 | 0.30 | 50 | 230 | 14 | 0.869 | 0.82 | 1.06 | B |
| 33 | a | 45 | 0.23 | 6.8 | 0.30 | 80 | 236 | 28 | 0.877 | 0.82 | 1.07 | B |
| 34 | a | 45 | 0.23 | 7.5 | 0.30 | 40 | 258 | 37 | 0.951 | 0.82 | 1.16 | D |
| 35 | a | 45 | 0.23 | 22 | 0.30 | 40 | 273 | 36 | 1.017 | 0.82 | 1.24 | D |
| 36 | a | 45 | 0.23 | 0 | 0.44 | 40 | 187 | 57 | 0.927 | 0.82 | 1.13 | D |
| 37 | a | 45 | 0.23 | 0.8 | 0.44 | 40 | 195 | 26 | 0.861 | 0.82 | 1.05 | B |
| 38 | a | 45 | 0.23 | 2.2 | 0.44 | 20 | 210 | 12 | 0.812 | 0.82 | 0.99 | A |
| 39 | a | 45 | 0.23 | 3.8 | 0.44 | 30 | 219 | 8 | 0.787 | 0.82 | 0.96 | A |
| 40 | a | 45 | 0.23 | 4.3 | 0.44 | 40 | 223 | 6 | 0.795 | 0.82 | 0.97 | A |
| 41 | a | 45 | 0.23 | 5.5 | 0.44 | 50 | 237 | 21 | 0.853 | 0.82 | 1.04 | A |
| 42 | a | 45 | 0.23 | 6.8 | 0.44 | 80 | 243 | 28 | 0.869 | 0.82 | 1.06 | B |
| 43 | a | 45 | 0.23 | 7.5 | 0.44 | 40 | 266 | 37 | 0.951 | 0.82 | 1.16 | D |
| 44 | a | 45 | 0.23 | 22 | 0.44 | 40 | 278 | 36 | 1.025 | 0.82 | 1.25 | D |
| 45 | a | 45 | 0.23 | 0 | 0.52 | 40 | 188 | 60 | 0.943 | 0.82 | 1.15 | D |
| 46 | a | 45 | 0.23 | 0.8 | 0.52 | 40 | 196 | 28 | 0.877 | 0.82 | 1.07 | B |

TABLE 4

| | | | | | | | | Absolute | | | | |
|---|---|---|---|---|---|---|---|---|---|---|---|---|
| | | | | | | | | value of | | | | |
| | | | | | | | | difference | | | | |
| | | | | | | | Average | in Vickers | | | | |
| | | | | | | | of Vickers | hardness | | | | |
| | | | | | Dynamic | | hardness | between | | | | |
| | | | | | friction | | in bent | bent | Iron | Iron | | |
| | | Target | Steel | | coefficient | | portion | portion | loss of | loss of | | |
| | | bent | sheet | Tensile | between | Punch | with | and planar | iron | steel | | |
| | Core | angle φ | thickness | stress | steel sheet | speed | n = 10 | portion | core | sheet | | |
| No. | No. | (°) | (mm) | (MPa) | and die 1 | (mm/sec) | (HV) | (HV) | (W/kg) | (W/kg) | BF | Result |
| 47 | a | 45 | 0.23 | 2.2 | 0.52 | 20 | 212 | 23 | 0.861 | 0.82 | 1.05 | B |
| 48 | a | 45 | 0.23 | 3.8 | 0.52 | 30 | 220 | 11 | 0.853 | 0.82 | 1.04 | A |
| 49 | a | 45 | 0.23 | 4.3 | 0.52 | 40 | 231 | 14 | 0.853 | 0.82 | 1.04 | A |
| 50 | a | 45 | 0.23 | 5.5 | 0.52 | 50 | 248 | 26 | 0.886 | 0.82 | 1.08 | B |
| 51 | a | 45 | 0.23 | 6.8 | 0.52 | 80 | 249 | 30 | 0.894 | 0.82 | 1.09 | B |
| 52 | a | 45 | 0.23 | 7.5 | 0.52 | 40 | 267 | 37 | 0.951 | 0.82 | 1.16 | D |
| 53 | a | 45 | 0.23 | 22 | 0.52 | 40 | 274 | 36 | 1.017 | 0.82 | 1.24 | D |
| 54 | a | 45 | 0.23 | 0 | 0.57 | 40 | 187 | 60 | 0.943 | 0.82 | 1.15 | D |
| 55 | a | 45 | 0.23 | 0.8 | 0.57 | 40 | 198 | 28 | 0.877 | 0.82 | 1.07 | B |
| 56 | a | 45 | 0.23 | 2.2 | 0.57 | 20 | 220 | 23 | 0.861 | 0.82 | 1.05 | A |
| 57 | a | 45 | 0.23 | 3.8 | 0.57 | 30 | 237 | 11 | 0.853 | 0.82 | 1.04 | A |
| 58 | a | 45 | 0.23 | 4.3 | 0.57 | 40 | 243 | 14 | 0.861 | 0.82 | 1.05 | B |
| 59 | a | 45 | 0.23 | 5.5 | 0.57 | 50 | 247 | 26 | 0.886 | 0.82 | 1.08 | B |
| 60 | a | 45 | 0.23 | 6.8 | 0.57 | 80 | 246 | 30 | 0.894 | 0.82 | 1.09 | B |
| 61 | a | 45 | 0.23 | 7.5 | 0.57 | 40 | 268 | 37 | 0.951 | 0.82 | 1.16 | D |
| 62 | a | 45 | 0.23 | 22 | 0.57 | 40 | 274 | 36 | 1.017 | 0.82 | 1.24 | D |
| 63 | a | 45 | 0.23 | 0 | 0.63 | 40 | 189 | 60 | 0.943 | 0.82 | 1.15 | D |
| 64 | a | 45 | 0.23 | 0.8 | 0.63 | 40 | 198 | 28 | 0.877 | 0.82 | 1.07 | B |
| 65 | a | 45 | 0.23 | 2.2 | 0.63 | 20 | 222 | 23 | 0.853 | 0.82 | 1.04 | A |
| 66 | a | 45 | 0.23 | 3.8 | 0.63 | 30 | 239 | 12 | 0.861 | 0.82 | 1.05 | B |
| 67 | a | 45 | 0.23 | 4.3 | 0.63 | 40 | 245 | 16 | 0.853 | 0.82 | 1.04 | A |
| 68 | a | 45 | 0.23 | 5.5 | 0.63 | 50 | 249 | 27 | 0.886 | 0.82 | 1.08 | B |
| 69 | a | 45 | 0.23 | 6.8 | 0.63 | 80 | 248 | 30 | 0.902 | 0.82 | 1.10 | B |

TABLE 5

| | | | | | | | | Absolute | | | | |
|---|---|---|---|---|---|---|---|---|---|---|---|---|
| | | | | | | | | value of | | | | |
| | | | | | | | | difference | | | | |
| | | | | | | | Average | in Vickers | | | | |
| | | | | | | | of Vickers | hardness | | | | |
| | | | | | Dynamic | | hardness | between | | | | |
| | | | | | friction | | in bent | bent | Iron | Iron | | |
| | | Target | Steel | | coefficient | | portion | portion | loss of | loss of | | |
| | | bent | sheet | Tensile | between | Punch | with | and planar | iron | steel | | |
| | Core | angle φ | thickness | stress | steel sheet | speed | n = 10 | portion | core | sheet | | |
| No. | No. | (°) | (mm) | (MPa) | and die 1 | (mm/sec) | (HV) | (HV) | (W/kg) | (W/kg) | BF | Result |
| 70 | a | 45 | 0.23 | 7.5 | 0.63 | 40 | 271 | 42 | 0.943 | 0.82 | 1.15 | D |
| 71 | a | 45 | 0.23 | 22 | 0.63 | 40 | 277 | 48 | 1.033 | 0.82 | 1.26 | D |
| 72 | a | 45 | 0.23 | 0 | 0.74 | 40 | 189 | 52 | 0.951 | 0.82 | 1.16 | D |
| 73 | a | 45 | 0.23 | 0.8 | 0.74 | 40 | 199 | 28 | 0.886 | 0.82 | 1.08 | B |
| 74 | a | 45 | 0.23 | 2.2 | 0.74 | 20 | 226 | 23 | 0.861 | 0.82 | 1.05 | B |
| 75 | a | 45 | 0.23 | 3.8 | 0.74 | 30 | 239 | 12 | 0.869 | 0.82 | 1.06 | B |
| 76 | a | 45 | 0.23 | 4.3 | 0.74 | 40 | 247 | 16 | 0.853 | 0.82 | 1.04 | A |
| 77 | a | 45 | 0.23 | 5.5 | 0.74 | 50 | 250 | 27 | 0.877 | 0.82 | 1.07 | B |
| 78 | a | 45 | 0.23 | 6.8 | 0.74 | 80 | 249 | 30 | 0.910 | 0.82 | 1.11 | B |
| 79 | a | 45 | 0.23 | 7.5 | 0.74 | 40 | 265 | 42 | 0.943 | 0.82 | 1.15 | D |
| 80 | a | 45 | 0.23 | 22 | 0.74 | 40 | 277 | 48 | 1.033 | 0.82 | 1.26 | D |
| 81 | a | 45 | 0.23 | 0 | 0.85 | 40 | 255 | 52 | 0.951 | 0.82 | 1.16 | D |
| 82 | a | 45 | 0.23 | 0.8 | 0.85 | 40 | 263 | 47 | 0.959 | 0.82 | 1.17 | D |
| 83 | a | 45 | 0.23 | 2.2 | 0.85 | 20 | 265 | 42 | 0.959 | 0.82 | 1.17 | D |
| 84 | a | 45 | 0.23 | 3.8 | 0.85 | 30 | 264 | 37 | 0.959 | 0.82 | 1.17 | D |
| 85 | a | 45 | 0.23 | 4.3 | 0.85 | 40 | 267 | 34 | 0.951 | 0.82 | 1.16 | D |
| 86 | a | 45 | 0.23 | 5.5 | 0.85 | 50 | 263 | 31 | 0.951 | 0.82 | 1.16 | D |
| 87 | a | 45 | 0.23 | 6.8 | 0.85 | 80 | 266 | 48 | 0.959 | 0.82 | 1.17 | D |
| 88 | a | 45 | 0.23 | 7.5 | 0.85 | 40 | 271 | 56 | 0.943 | 0.82 | 1.15 | D |
| 89 | a | 45 | 0.23 | 22 | 0.85 | 40 | 277 | 57 | 1.041 | 0.82 | 1.27 | D |
| 90 | a | 45 | 0.23 | 0 | 0.93 | 40 | 255 | 52 | 0.959 | 0.82 | 1.17 | D |
| 91 | a | 45 | 0.23 | 0.8 | 0.93 | 40 | 257 | 47 | 0.959 | 0.82 | 1.17 | D |
| 92 | a | 45 | 0.23 | 2.2 | 0.93 | 20 | 265 | 42 | 0.959 | 0.82 | 1.17 | D |

TABLE 6

| | | | | | | | | Absolute | | | | |
|---|---|---|---|---|---|---|---|---|---|---|---|---|
| | | | | | | | | value of | | | | |
| | | | | | | | | difference | | | | |
| | | | | | | | Average | in Vickers | | | | |
| | | | | | | | of Vickers | hardness | | | | |
| | | | | | Dynamic | | hardness | between | | | | |
| | | | | | friction | | in bent | bent | Iron | Iron | | |
| | | Target | Steel | | coefficient | | portion | portion | loss of | loss of | | |
| | | bent | sheet | Tensile | between | Punch | with | and planar | iron | steel | | |
| | Core | angle φ | thickness | stress | steel sheet | speed | n = 10 | portion | core | sheet | | |
| No. | No. | (°) | (mm) | (MPa) | and die 1 | (mm/sec) | (HV) | (HV) | (W/kg) | (W/kg) | BF | Result |
| 93 | a | 45 | 0.23 | 3.8 | 0.93 | 30 | 266 | 37 | 0.959 | 0.82 | 1.17 | D |
| 94 | a | 45 | 0.23 | 4.3 | 0.93 | 40 | 267 | 34 | 0.951 | 0.82 | 1.16 | D |
| 95 | a | 45 | 0.23 | 5.5 | 0.93 | 50 | 263 | 31 | 0.951 | 0.82 | 1.16 | D |
| 96 | a | 45 | 0.23 | 6.8 | 0.93 | 80 | 266 | 48 | 0.959 | 0.82 | 1.17 | D |
| 97 | a | 45 | 0.23 | 7.5 | 0.93 | 40 | 268 | 56 | 0.959 | 0.82 | 1.17 | D |
| 98 | a | 45 | 0.23 | 22 | 0.93 | 40 | 276 | 57 | 1.041 | 0.82 | 1.27 | D |
| 99 | b | 45 | 0.23 | 0 | 0.03 | 40 | 169 | 52 | 0.943 | 0.82 | 1.15 | D |
| 100 | b | 45 | 0.23 | 0.8 | 0.03 | 40 | 170 | 47 | 0.951 | 0.82 | 1.16 | D |
| 101 | b | 45 | 0.23 | 2.2 | 0.03 | 20 | 172 | 42 | 0.943 | 0.82 | 1.15 | D |
| 102 | b | 45 | 0.23 | 3.8 | 0.03 | 30 | 173 | 37 | 0.935 | 0.82 | 1.14 | C |
| 103 | b | 45 | 0.23 | 4.3 | 0.03 | 40 | 176 | 34 | 0.951 | 0.82 | 1.16 | D |
| 104 | b | 45 | 0.23 | 5.5 | 0.03 | 50 | 172 | 31 | 0.943 | 0.82 | 1.15 | D |
| 105 | b | 45 | 0.23 | 6.8 | 0.03 | 80 | 175 | 48 | 0.943 | 0.82 | 1.15 | D |
| 106 | b | 45 | 0.23 | 7.5 | 0.03 | 40 | 172 | 56 | 0.943 | 0.82 | 1.15 | D |
| 107 | b | 45 | 0.23 | 22 | 0.03 | 40 | 175 | 57 | 1.017 | 0.82 | 1.24 | D |
| 108 | b | 45 | 0.23 | 0 | 0.44 | 40 | 174 | 57 | 0.927 | 0.82 | 1.13 | C |
| 109 | b | 45 | 0.23 | 0.8 | 0.44 | 40 | 195 | 26 | 0.861 | 0.82 | 1.05 | B |
| 110 | b | 45 | 0.23 | 2.2 | 0.44 | 20 | 210 | 12 | 0.820 | 0.82 | 1.00 | A |
| 111 | b | 45 | 0.23 | 3.8 | 0.44 | 30 | 221 | 8 | 0.787 | 0.82 | 0.96 | A |
| 112 | b | 45 | 0.23 | 4.3 | 0.44 | 40 | 223 | 6 | 0.804 | 0.82 | 0.98 | A |
| 113 | b | 45 | 0.23 | 7.5 | 0.44 | 40 | 182 | 37 | 0.951 | 0.82 | 1.16 | D |
| 114 | b | 45 | 0.23 | 22 | 0.44 | 40 | 278 | 36 | 1.025 | 0.82 | 1.25 | D |
| 115 | b | 45 | 0.23 | 0 | 0.80 | 40 | 255 | 52 | 0.951 | 0.82 | 1.16 | D |

TABLE 7

| | | | | | | | | Absolute | | | | |
|---|---|---|---|---|---|---|---|---|---|---|---|---|
| | | | | | | | | value of | | | | |
| | | | | | | | | difference | | | | |
| | | | | | | | Average | in Vickers | | | | |
| | | | | | | | of Vickers | hardness | | | | |
| | | | | | Dynamic | | hardness | between | | | | |
| | | | | | friction | | in bent | bent | Iron | Iron | | |
| | | Target | Steel | | coefficient | | portion | portion | loss of | loss of | | |
| | | bent | sheet | Tensile | between | Punch | with | and planar | iron | steel | | |
| | Core | angle φ | thickness | stress | steel sheet | speed | n = 10 | portion | core | sheet | | |
| No. | No. | (°) | (mm) | (MPa) | and die 1 | (mm/sec) | (HV) | (HV) | (W/kg) | (W/kg) | BF | Result |
| 116 | b | 45 | 0.23 | 0.8 | 0.80 | 40 | 265 | 47 | 0.959 | 0.82 | 1.17 | D |
| 117 | b | 45 | 0.23 | 2.2 | 0.80 | 20 | 265 | 42 | 0.943 | 0.82 | 1.15 | D |
| 118 | b | 45 | 0.23 | 3.8 | 0.80 | 30 | 264 | 37 | 0.959 | 0.82 | 1.17 | D |
| 119 | b | 45 | 0.23 | 4.3 | 0.80 | 40 | 267 | 34 | 0.951 | 0.82 | 1.16 | D |
| 120 | b | 45 | 0.23 | 5.5 | 0.80 | 50 | 266 | 31 | 0.951 | 0.82 | 1.16 | D |
| 121 | b | 45 | 0.23 | 6.8 | 0.80 | 80 | 266 | 48 | 0.951 | 0.82 | 1.16 | D |
| 122 | b | 45 | 0.23 | 7.5 | 0.80 | 40 | 271 | 56 | 0.943 | 0.82 | 1.15 | D |
| 123 | b | 45 | 0.23 | 22 | 0.80 | 40 | 277 | 57 | 1.033 | 0.82 | 1.26 | D |
| 124 | d | 30 | 0.23 | 0 | 0.44 | 40 | 188 | 36 | 0.927 | 0.82 | 1.13 | D |
| 125 | d | 30 | 0.23 | 0.8 | 0.44 | 40 | 195 | 23 | 0.869 | 0.82 | 1.06 | B |
| 126 | d | 30 | 0.23 | 2.2 | 0.44 | 20 | 210 | 10 | 0.836 | 0.82 | 1.02 | A |
| 127 | d | 30 | 0.23 | 3.8 | 0.44 | 30 | 218 | 6 | 0.804 | 0.82 | 0.98 | A |
| 128 | d | 30 | 0.23 | 4.3 | 0.44 | 40 | 223 | 3 | 0.795 | 0.82 | 0.97 | A |
| 129 | d | 30 | 0.23 | 5.5 | 0.44 | 50 | 193 | 14 | 0.861 | 0.82 | 1.05 | B |
| 130 | d | 30 | 0.23 | 6.8 | 0.44 | 80 | 194 | 21 | 0.877 | 0.82 | 1.07 | B |
| 131 | d | 30 | 0.23 | 22 | 0.44 | 40 | 278 | 42 | 1.050 | 0.82 | 1.28 | D |
| 132 | e | 90 | 0.23 | 0 | 0.44 | 40 | 255 | 56 | 1.009 | 0.82 | 1.23 | D |
| 133 | e | 90 | 0.23 | 0.8 | 0.44 | 40 | 263 | 57 | 0.992 | 0.82 | 1.21 | D |
| 134 | e | 90 | 0.23 | 2.2 | 0.44 | 20 | 264 | 52 | 1.009 | 0.82 | 1.23 | D |
| 135 | e | 90 | 0.23 | 3.8 | 0.44 | 30 | 264 | 47 | 1.000 | 0.82 | 1.22 | D |
| 136 | e | 90 | 0.23 | 4.3 | 0.44 | 40 | 265 | 42 | 0.992 | 0.82 | 1.21 | D |
| 137 | e | 30 | 0.23 | 5.5 | 0.44 | 50 | 266 | 48 | 1.009 | 0.82 | 1.23 | D |
| 138 | e | 30 | 0.23 | 6.8 | 0.44 | 80 | 267 | 56 | 0.984 | 0.82 | 1.20 | D |

TABLE 8

| | | | | | | | | Absolute | | | | |
|---|---|---|---|---|---|---|---|---|---|---|---|---|
| | | | | | | | | value of | | | | |
| | | | | | | | | difference | | | | |
| | | | | | | | Average | in Vickers | | | | |
| | | | | | | | of Vickers | hardness | | | | |
| | | | | | Dynamic | | hardness | between | | | | |
| | | | | | friction | | in bent | bent | Iron | Iron | | |
| | | Target | Steel | | coefficient | | portion | portion | loss of | loss of | | |
| | | bent | sheet | Tensile | between | Punch | with | and planar | iron | steel | | |
| | Core | angle φ | thickness | stress | steel sheet | speed | n = 10 | portion | core | sheet | | |
| No. | No. | (°) | (mm) | (MPa) | and die 1 | (mm/sec) | (HV) | (HV) | (W/kg) | (W/kg) | BF | Result |
| 139 | e | 30 | 0.23 | 7.5 | 0.44 | 40 | 271 | 57 | 0.992 | 0.82 | 1.21 | D |
| 140 | e | 30 | 0.23 | 22 | 0.44 | 40 | 277 | 52 | 1.000 | 0.82 | 1.22 | D |
| 141 | a | 45 | 0.15 | 0.8 | 0.44 | 40 | 192 | 20 | 0.877 | 0.82 | 1.07 | B |
| 142 | a | 45 | 0.15 | 3.8 | 0.44 | 40 | 203 | 0 | 0.812 | 0.82 | 0.99 | A |
| 143 | a | 45 | 0.15 | 7 | 0.44 | 20 | 260 | 41 | 0.959 | 0.82 | 1.17 | D |
| 144 | a | 45 | 0.18 | 0.8 | 0.44 | 30 | 197 | 18 | 0.853 | 0.82 | 1.04 | A |
| 145 | a | 45 | 0.18 | 4.3 | 0.44 | 40 | 213 | 2 | 0.779 | 0.82 | 0.95 | A |
| 146 | a | 45 | 0.27 | 0.8 | 0.44 | 80 | 198 | 18 | 0.853 | 0.82 | 1.04 | A |
| 147 | a | 45 | 0.27 | 4.3 | 0.44 | 40 | 210 | 0 | 0.779 | 0.82 | 0.95 | A |
| 148 | a | 45 | 0.27 | 6.8 | 0.44 | 40 | 231 | 20 | 0.869 | 0.82 | 1.06 | B |
| 149 | a | 45 | 0.27 | 7 | 0.44 | 40 | 256 | 49 | 0.959 | 0.82 | 1.17 | D |
| 150 | a | 45 | 0.3 | 0.8 | 0.44 | 40 | 191 | 17 | 0.861 | 0.82 | 1.05 | B |
| 151 | a | 45 | 0.3 | 4.3 | 0.44 | 20 | 202 | 4 | 0.795 | 0.82 | 0.97 | A |
| 152 | a | 45 | 0.3 | 6.8 | 0.44 | 30 | 244 | 18 | 0.877 | 0.82 | 1.07 | B |
| 153 | a | 45 | 0.3 | 7. | 0.44 | 40 | 264 | 50 | 0.968 | 0.82 | 1.18 | D |
| 154 | a | 45 | 0.35 | 0.8 | 0.44 | 50 | 191 | 17 | 0.861 | 0.82 | 1.05 | B |
| 155 | a | 45 | 0.35 | 3.8 | 0.44 | 80 | 202 | 3 | 0.795 | 0.82 | 0.97 | A |
| 156 | a | 45 | 0.35 | 6.8 | 0.44 | 40 | 244 | 15 | 0.877 | 0.82 | 1.07 | B |
| 157 | a | 45 | 0.35 | 7.2 | 0.44 | 40 | 264 | 40 | 0.968 | 0.82 | 1.18 | D |
| 158 | a | 45 | 0.23 | 8.5 | 0.10 | 40 | 253 | 39 | 0.951 | 0.82 | 1.16 | D |
| 159 | b | 45 | 0.23 | 5.5 | 0.44 | 40 | 196 | 23 | 0.853 | 0.82 | 1.04 | A |
| 160 | b | 45 | 0.23 | 6.8 | 0.44 | 60 | 210 | 26 | 0.869 | 0.82 | 1.06 | B |
| 161 | d | 30 | 0.23 | 7.5 | 0.44 | 80 | 251 | 38 | 0.959 | 0.82 | 1.14 | C |

TABLE 9

| | | | | | | | | Absolute | | | | |
|---|---|---|---|---|---|---|---|---|---|---|---|---|
| | | | | | | | | value of | | | | |
| | | | | | | | | difference | | | | |
| | | | | | | | Average | in Vickers | | | | |
| | | | | | | | of Vickers | hardness | | | | |
| | | | | | Dynamic | | hardness | between | | | | |
| | | | | | friction | | in bent | bent | Iron | Iron | | |
| | | Target | Steel | | coefficient | | portion | portion | loss of | loss of | | |
| | | bent | sheet | Tensile | between | Punch | with | and planar | iron | steel | | |
| | Core | angle φ | thickness | stress | steel sheet | speed | n = 10 | portion | core | sheet | | |
| No. | No. | (°) | (mm) | (MPa) | and die 1 | (mm/sec) | (HV) | (HV) | (W/kg) | (W/kg) | BF | Result |
| 162 | a | 45 | 0.18 | 6.8 | 0.44 | 40 | 226 | 18 | 0.935 | 0.82 | 1.05 | B |
| 163 | f | 45 | 0.23 | 0 | 0.30 | 40 | 182 | 60 | 0.927 | 0.82 | 1.13 | C |
| 164 | f | 45 | 0.23 | 0.8 | 0.30 | 40 | 193 | 26 | 0.861 | 0.82 | 1.05 | B |
| 165 | f | 45 | 0.23 | 2.2 | 0.30 | 20 | 200 | 11 | 0.845 | 0.82 | 1.03 | A |
| 166 | f | 45 | 0.23 | 3.8 | 0.30 | 30 | 213 | 6 | 0.836 | 0.82 | 1.02 | A |
| 167 | f | 45 | 0.23 | 4.3 | 0.30 | 40 | 222 | 5 | 0.828 | 0.82 | 1.01 | A |
| 168 | f | 45 | 0.23 | 5.5 | 0.30 | 50 | 230 | 14 | 0.869 | 0.82 | 1.06 | B |
| 169 | f | 45 | 0.23 | 6.8 | 0.30 | 80 | 236 | 29 | 0.877 | 0.82 | 1.07 | B |
| 170 | f | 45 | 0.23 | 7.5 | 0.30 | 40 | 258 | 42 | 0.951 | 0.82 | 1.16 | D |
| 171 | f | 45 | 0.23 | 22 | 0.30 | 40 | 273 | 38 | 1.017 | 0.82 | 1.24 | D |
| 172 | f | 45 | 0.23 | 0 | 0.07 | 30 | 186 | 55 | 0.943 | 0.82 | 1.15 | D |
| 173 | f | 45 | 0.23 | 0.8 | 0.07 | 40 | 169 | 47 | 0.951 | 0.82 | 1.16 | D |
| 174 | f | 45 | 0.23 | 2.2 | 0.07 | 20 | 172 | 40 | 0.943 | 0.82 | 1.15 | D |
| 175 | f | 45 | 0.23 | 3.8 | 0.07 | 30 | 179 | 53 | 0.943 | 0.82 | 1.15 | D |
| 176 | f | 45 | 0.23 | 4.3 | 0.07 | 40 | 180 | 49 | 0.951 | 0.82 | 1.16 | D |
| 177 | f | 45 | 0.23 | 5.5 | 0.07 | 50 | 183 | 56 | 0.943 | 0.82 | 1.15 | D |
| 178 | f | 45 | 0.23 | 6.8 | 0.07 | 80 | 182 | 68 | 0.943 | 0.82 | 1.15 | D |
| 179 | f | 45 | 0.23 | 7.5 | 0.07 | 100 | 179 | 77 | 0.943 | 0.82 | 1.15 | D |
| 180 | f | 45 | 0.23 | 22 | 0.07 | 150 | 187 | 87 | 1.009 | 0.82 | 1.23 | D |
| 181 | a | 45 | 0.23 | 2.2 | 0.10 | 18 | 196 | 37 | 0.877 | 0.82 | 1.07 | B |
| 182 | a | 45 | 0.23 | 3.8 | 0.10 | 100 | 196 | 45 | 0.918 | 0.82 | 1.12 | B |
| 183 | a | 45 | 0.23 | 4.3 | 0.10 | 90 | 200 | 48 | 0.902 | 0.82 | 1.10 | B |

TABLE 10

| | | | | | | | | Absolute | | | | |
|---|---|---|---|---|---|---|---|---|---|---|---|---|
| | | | | | | | | value of | | | | |
| | | | | | | | | difference | | | | |
| | | | | | | | Average | in Vickers | | | | |
| | | | | | | | of Vickers | hardness | | | | |
| | | | | | Dynamic | | hardness | between | | | | |
| | | | | | friction | | in bent | bent | Iron | Iron | | |
| | | Target | Steel | | coefficient | | portion | portion | loss of | loss of | | |
| | | bent | sheet | Tensile | between | Punch | with | and planar | iron | steel | | |
| | Core | angle φ | thickness | stress | steel sheet | speed | n = 10 | portion | core | sheet | | |
| No. | No. | (°) | (mm) | (MPa) | and die 1 | (mm/sec) | (HV) | (HV) | (W/kg) | (W/kg) | BF | Result |
| 184 | d | 30 | 0.23 | 2.2 | 0.44 | 17 | 210 | 40 | 0.845 | 0.82 | 1.03 | A |
| 185 | d | 30 | 0.23 | 3.8 | 0.44 | 84 | 218 | 57 | 0.902 | 0.82 | 1.10 | B |
| 186 | d | 30 | 0.23 | 4.3 | 0.44 | 200 | 223 | 70 | 0.918 | 0.82 | 1.12 | B |
| 187 | c | 45 | 0.23 | 0 | 0.30 | 40 | 182 | 46 | 0.951 | 0.82 | 1.16 | D |
| 188 | c | 45 | 0.23 | 0.8 | 0.30 | 40 | 190 | 47 | 0.959 | 0.82 | 1.12 | B |
| 189 | c | 45 | 0.23 | 2.2 | 0.30 | 20 | 192 | 42 | 0.943 | 0.82 | 1.11 | B |
| 190 | c | 45 | 0.23 | 3.8 | 0.30 | 30 | 194 | 37 | 0.959 | 0.82 | 1.05 | B |
| 191 | c | 45 | 0.23 | 4.3 | 0.30 | 40 | 196 | 41 | 0.951 | 0.82 | 1.06 | B |
| 192 | c | 45 | 0.23 | 5.5 | 0.30 | 50 | 196 | 46 | 0.951 | 0.82 | 1.10 | B |
| 193 | c | 45 | 0.23 | 6.8 | 0.30 | 80 | 198 | 48 | 0.951 | 0.82 | 1.11 | B |
| 194 | c | 45 | 0.23 | 7.5 | 0.30 | 40 | 188 | 49 | 0.943 | 0.82 | 1.14 | C |
| 195 | c | 45 | 0.23 | 22 | 0.30 | 40 | 187 | 55 | 0.976 | 0.82 | 1.19 | D |
| 196 | c | 45 | 0.23 | 0 | 0.80 | 40 | 183 | 52 | 0.951 | 0.82 | 1.16 | D |
| 197 | c | 45 | 0.23 | 0.8 | 0.80 | 40 | 184 | 47 | 0.959 | 0.82 | 1.17 | D |
| 198 | c | 45 | 0.23 | 2.2 | 0.80 | 20 | 185 | 42 | 0.959 | 0.82 | 1.15 | D |
| 199 | c | 45 | 0.23 | 3.8 | 0.80 | 30 | 186 | 37 | 0.959 | 0.82 | 1.17 | D |
| 200 | c | 45 | 0.23 | 4.3 | 0.80 | 40 | 188 | 34 | 0.951 | 0.82 | 1.16 | D |
| 201 | c | 45 | 0.23 | 5.5 | 0.80 | 50 | 187 | 31 | 0.959 | 0.82 | 1.16 | D |
| 202 | c | 45 | 0.23 | 6.8 | 0.80 | 80 | 188 | 48 | 0.951 | 0.82 | 1.16 | D |
| 203 | c | 45 | 0.23 | 7.5 | 0.80 | 40 | 188 | 56 | 0.943 | 0.82 | 1.15 | D |
| 204 | c | 45 | 0.23 | 22 | 0.80 | 40 | 187 | 57 | 0.976 | 0.82 | 1.26 | D |

As can be, understood from Table 2 to Table 10, regarding the iron cores of the cores Nos. a, b, d, and f forming a Unicore type having a small radius of curvature r (5 mm or less) of the bent portion 5, regardless of the sheet thickness, if the average Vickers hardness at 10 arbitrary points in the L cross section of the steel sheet 1 was 190 to 250 HV, that is, the tensile stress applied to the steel sheet during steel sheet processing was set to 0.8 MPa or more and 6.8 MPa or less, and the dynamic friction coefficient between the steel sheet and the dies 52a and 52b (bending tool) was set to 0.10 or more and 0.74 or less, the building factor (BF) was reduced to be less than 1.13 (the iron loss of the wound core was minimized). On the other hand, in the case of the iron core of the core No. c forming a Unicore type having a bent portion with a radius of curvature of 6 mm and the iron core of the core No. e forming a trunk core type, even if the tensile stress applied to the steel sheet, during steel sheet processing was set to 0.8 MPa or more and 6.8 MPa or less and the dynamic friction coefficient between the steel sheet and the dies 52a and 52b (bending tool) was set to 0.10 or more and 0.74 or less, the average Vickers hardness in the L cross section of the steel sheet 1 did not fall within a range of 190 to 250 HV, and, the building factor (BF) could not be sufficiently minimized.

Based on the above results, it can be clearly understood that the wound core of the present invention including the present embodiment had a Unicore type, the average Vickers hardness at 10 arbitrary points in the L cross section of the grain-oriented electrical steel sheet 1 was 190 to 250 HV, and deterioration of the iron loss was reduced.

### APPENDIX

A wound core, a method of producing a wound core, and a wound core production device according to the above embodiments can be understood as follows.

A wound core of the present disclosure that is a wound core having a wound shape including a rectangular hollow portion in a center and a portion in which grain-oriented electrical steel sheets in which planar portions and bent portions are alternately continuous in a longitudinal direction are stacked in a sheet thickness direction, which is a wound core formed by stacking the grain-oriented electrical steel sheets that have been individually bent in layers and assembled into a wound shape and in which the plurality of grain-oriented electrical steel sheets are connected to each other via at least one joining part for each roll, wherein any one or more of the arbitrary bent portions among the laminated grain-oriented electrical steel sheets have an average Vickers hardness of 190 to 250 HV at 10 arbitrary points in the L cross section in the longitudinal direction which is a cross section of the grain-oriented electrical steel sheet in the thickness direction.

A method of producing a wound core of the present disclosure is a method of producing a wound core that is a wound core having a wound shape including a rectangular hollow portion in a center and a portion in which grain-oriented electrical steel sheets in which planar portions and bent portions are alternately continuous in a longitudinal direction are stacked in a sheet thickness direction which is a wound core formed by stacking the grain-oriented electrical steel sheets that have been individually bent in layers and assembled into a wound shape and in which the plurality of grain-oriented electrical steel sheets are connected to each other via at least one joining part for each roll, in which, when the grain-oriented electrical steel sheet is bent while applying a tensile stress in a range of 0.8 MPa or more and 6.8 MPa or less to the grain-oriented electrical steel sheet in the longitudinal direction and/or the coefficient of friction between a bending tool that bends the grain-oriented electrical steel sheet and the grain-oriented electrical steel sheet is bent by setting the grain-oriented electrical steel sheet to 0.10 or more and 0.74 or less, any one or more of the arbitrary bent portions among the laminated grain-oriented electrical steel sheets are formed.

A wound core production device of the present disclosure includes a bending unit that individually bends grain-oriented electrical steel sheets and an assembly unit that stacks the grain-oriented electrical steel sheets that have been individually bent in layers by the bending unit and assembles them into a wound shape to form a wound core having a wound shape including a rectangular hollow portion in a center in which the plurality of grain-oriented electrical steel sheets are connected to each other via at least one joining part for each roll and which includes a portion in which grain-oriented electrical steel sheets in which planar portions and bent portions are alternately continuous in a longitudinal direction are stacked in a sheet thickness direction, in which the bending unit bends the grain-oriented electrical steel sheet while applying a tensile stress in a range of 0.8 MPa or more and 6.8 MPa or less to the grain-oriented electrical steel sheet in the longitudinal direction and/or the grain-oriented electrical steel sheet is bent by setting the coefficient of friction between a bending tool that bends the grain-oriented electrical steel sheet and the grain-oriented electrical steel sheet to 0.10 or more and 0.74 or less, and thereby any one or more of the arbitrary bent portions among the laminated grain-oriented electrical steel sheets are formed.

### Brief Description of the Reference Symbols

1 Grain-oriented electrical steel sheet
4 Planar portion
5 Bent portion
6 Joining part
10 Wound core (wound core main body)

1. A wound core having a wound shape including a rectangular hollow portion in a center and a portion in which grain-oriented electrical steel sheets in which planar portions and bent portions are alternately continuous in a longitudinal direction are stacked in a sheet thickness direction, which is a wound core formed by stacking the grain-oriented electrical steel sheets that have been individually bent in layers and assembled into a wound shape and in which the plurality of grain-oriented electrical steel sheets are connected to each other via at least one joining part for each roll,
wherein the bent portion of the laminated grain-oriented electrical steel sheet has an average Vickers hardness of 190 to 250 HV in an L cross section in, the longitudinal direction which is a cross section of the grain-oriented electrical steel sheet in a thickness direction.

2. A method of producing a wound core that is a wound core having a wound shape including a rectangular hollow portion in a center and a portion in which grain-oriented electrical steel sheets in which planar portions and bent portions are alternately continuous in a longitudinal direction are stacked in a sheet thickness direction, which is a wound core formed by stacking the grain-oriented electrical steel sheets that have been individually bent in layers and assembled into a wound shape and in which the plurality of grain-oriented electrical steel sheets are connected to each other via at least one joining part for each roll, the method comprising:
bending the grain-oriented electrical steel sheet while applying a tensile stress in a range of 0.8 MPa or more and 6.8 MPa or less to the grain-oriented electrical steel sheet in the longitudinal direction and
bending the grain-oriented electrical steel sheet by setting a dynamic friction coefficient between a bending tool that bends the grain-oriented electrical steel sheet and the grain-oriented electrical steel sheet to 0.10 or more and 0.74 or less, and thereby
forming the bent portion of the laminated grain-oriented electrical steel sheets.

3. A wound core production device, comprising:
a bending unit that individually bends grain-oriented electrical steel sheets; and
an assembly unit that stacks the grain-oriented electrical steel, sheets that have been individually bent in layers by the bending unit and assembles them into a wound shape to form a wound core having a wound shape including a rectangular hollow portion in a center in which the plurality of grain-oriented electrical steel sheets are connected to each other via at least one joining part for each roll and which includes a portion in which grain-oriented electrical steel sheets in which planar portions and bent portions are alternately continuous in a longitudinal direction are stacked in a sheet thickness direction,
wherein the bending unit bends the grain-oriented electrical steel sheet while applying a tensile stress in a range of 0.8 MPa or more and 6.8 MPa or less to the grain-oriented electrical steel sheet in the longitudinal direction and bends the grain-oriented electrical steel sheet by setting a dynamic friction coefficient between a bending tool that bends the grain-oriented electrical steel sheet and the grain-oriented electrical steel sheet to 0.10 or more and 0.74 or less, and thereby forms the bent portion of the laminated grain-oriented electrical steel sheets.
